(19) United States
(12) Patent Application Publication
(10) Pub. No.: US 2013/0325618 A1
(43) Pub. Date: Dec. 5, 2013

(54) SYSTEMS AND METHODS FOR MOBILE MARKETING

(71) Applicant: Sunil Baliga, Cupertino, CA (US)

(72) Inventor: Sunil Baliga, Cupertino, CA (US)

(21) Appl. No.: 13/903,990

(22) Filed: May 28, 2013

Related U.S. Application Data
(60) Provisional application No. 61/654,075, filed on May 31, 2012.

(51) Int. Cl. G06Q 30/02

(52) U.S. Cl. CPC G06Q 30/0267
USPC 705/14.61

(57) ABSTRACT

A method is disclosed for delivering content to a mobile device by receiving a content set consisting of campaigns, variation selections, and one or more targeting filters; enabling campaign access to content via a single access point and Variations specify which content is included in the content set and one or more predetermined times to deliver a particular content set; and targeting filters to select content from a particular content set to send to the mobile device.

This application is a non-provisional application of Provisional Application Ser. 61654075 filed May 31, 2012, the content of which is incorporated by reference.

### BACKGROUND

The increasing popularity and sophistication of mobile devices, such as cellular telephones, tablets, connected automobiles, has led to explosive growth in mobile marketing. The goals of such mobile marketing often includes achieving conversions, i.e., having customers take actions such as submitting a form, watching a video, purchasing a product or service on their mobile device, etc.

Mobile devices, inherently having no fixed location, offer capabilities not found in traditional online marketing, i.e., marketing to customers' desktop or notebook computers, to their connected televisions, etc. These capabilities primarily revolve around the mobile device's location and time of day, day of the week, and/or month of the year.

Mobile marketing is subject to conditions typically not found in traditional online marketing. These conditions include cellular network congestion, a wide variety of devices with different specifications such as screen sizes, operating systems, etc.

U.S. Pat. No. 6,915,328 discloses a methodology of maximizing conversions on mobile devices by taking advantage of the new capabilities offered by mobile devices while operating within the constraints imposed by mobile devices.

### SUMMARY

A method is disclosed for delivering content to a mobile device by receiving a content set consisting of campaigns, variation selections, and one or more targeting filters; enabling campaign access to content via a single access point and Variations specify which content is included in the content set and one or more predetermined times to deliver a particular content set; and targeting filters to select content from a particular content set to send to the mobile device.

When conducting mobile marketing, marketers need to use a Content Set consisting of Campaigns and Variations, and Targeting filters. Campaigns enable access to content via a single access point and Variations specify which content is included in the content set and at what day and time to deliver a particular content set. Targeting filters select the appropriate content from the particular content set to send back to the mobile device.

Advantages of the system may include one or more of the following. The system provides a methodology for combining Campaigns, Variations, and Targeting all-in-one. By combining these capabilities, marketers can ensure that the right content is delivered to the right person at the right time, thus delivering more conversions than conventional systems generally do not combine these capabilities all-in-one. The methodology described herein applies to any mobile marketing access point, i.e., URL, SMS, QR Code, etc. and any mobile marketing content, i.e., advertisements, landing pages, etc. For example, a mobile marketer can use the all-in-one methodology specified herein to conduct A-B split testing for mobile web or in-Application marketing to Smartphones, Day-Parting for SMS marketing to feature phones, among others.

### BRIEF DESCRIPTION OF THE DRAWINGS

FIG. 1 shows an exemplary Mobile Marketing System.

FIG. 2 shows an exemplary Campaigns Engine.

FIG. 3 shows an exemplary Variations Engine.

FIG. 4 shows an exemplary Targeting Engine.

FIG. 5 shows an exemplary A/B Split Test.

FIG. 6 shows an exemplary Time-Based Content Delivery.

FIG. 7 shows an exemplary Language Based Delivery of Content.

FIG. 8 illustrates an exemplary Location Based Delivery of Content

FIG. 9 shows an exemplary Delivery of Content Based on Mobile Device Operating System.

FIG. 10 shows an exemplary Location and Time-Based Delivery of Content.

FIG. 11 is an exemplary process for Delivery of Content Using Mobile Device Type (Phone vs. Tablet), Browser Language, and Location.

FIG. 12 shows an exemplary Delivery of Content Using Area Code.

### DESCRIPTION

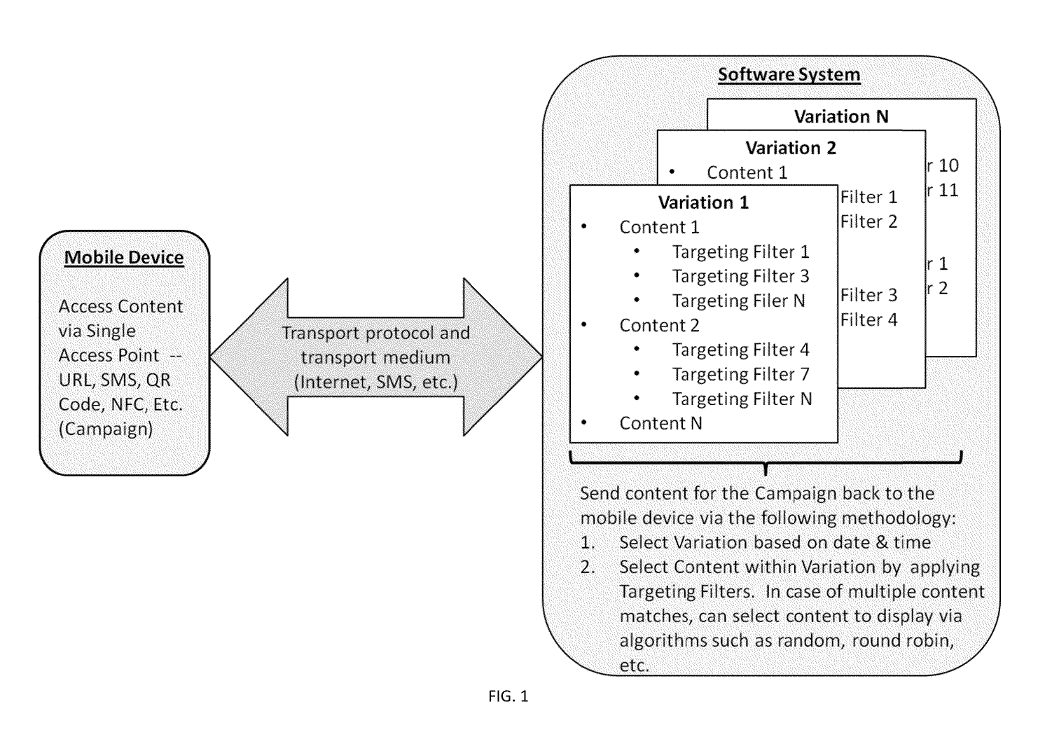

FIG. 1 shows an exemplary system supporting Campaigns, Variations, and Targeting Filters. When marketers create marketing content to be displayed on mobile devices, they can specify Targeting filters, i.e., a list of matching conditions on mobile devices, such as certain operating system(s), proximity of a location(s), mobile device browser language, etc. These conditions do not have to be mutually exclusive, they can be inclusive.

Via Campaigns and Variations, marketers can then deliver the desired content to mobile devices. Campaigns and Variations together define a higher-level construct, encompassing a content set. Campaigns provide a means for customers to access the content set via a single access point, such as a URL, a SMS keyword and short code or long code combination, or a QR Code. Variations enable the marketer to specify which content is to be included in the content set and at what day and time to deliver a particular content set, with day and start and stop times specified by the marketer.

Targeting select the appropriate content from the particular content set to send back to the mobile device. The entire Campaign, Variations, and Targeting sequence can be executed on each access point request from a mobile device. As such, requests to the same access point can be responded back to with different content; the responses do not necessarily have to be with the same content.

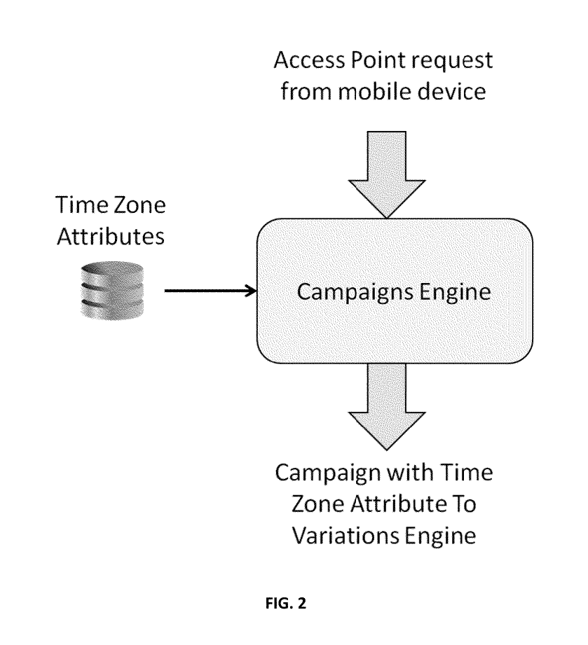

FIG. 2 shows an exemplary Campaigns Engine. When an access point is accessed by the mobile device, that access request is sent via an appropriate transport protocol and transport medium (Internet, SMS, etc.) to the Campaigns Engine in software system. Access requests may come from any time zone around the world, time zones which may be different than the time zone(s) in which the computing system(s) on which software system executes is located. Each access request is matched by the Campaigns Engine to an individual campaign. Attributes of that individual campaign, including applicable time zone(s) are then sent to the Variations Engine by the Campaigns Engine.

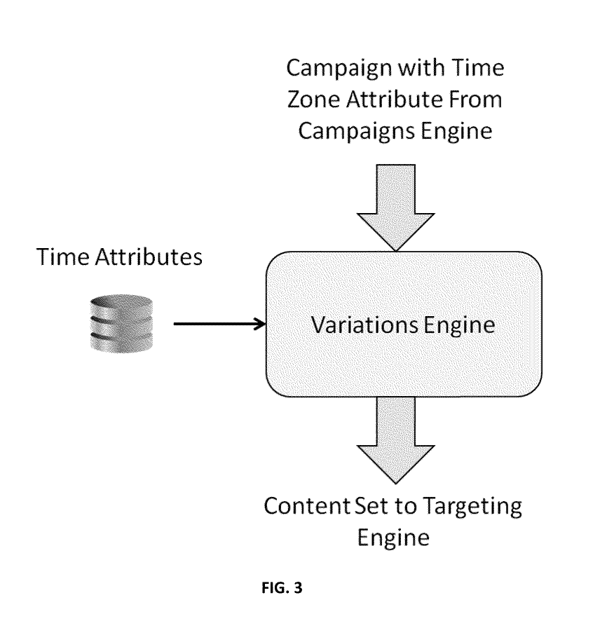

FIG. 3 shows an exemplary Variations Engine. Upon receiving information from the Campaigns Engine, the Variations Engine calculates the current date and time in the time zone(s) for the applicable Campaign and compares it against the time zone attributes to select the matching Variation specified by for that Campaign. Once the appropriate Variation is determined, the Variations Engine sends the content set for the matched Variation to the Targeting Engine.

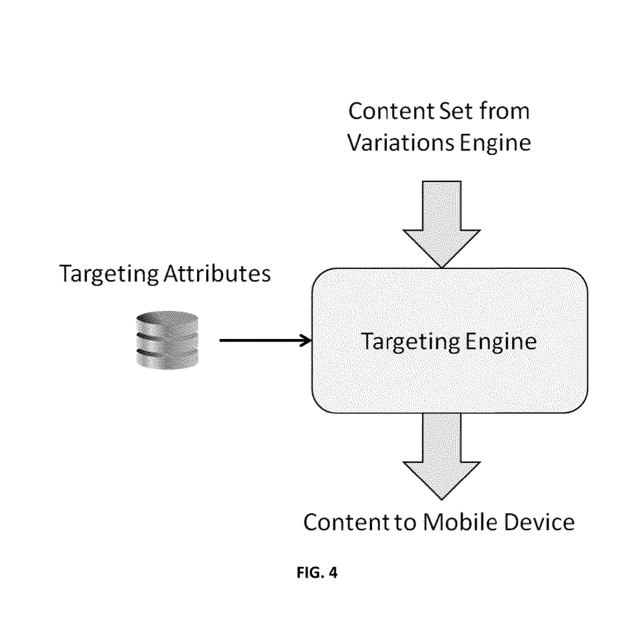

FIG. 4 shows an exemplary Targeting Engine. Upon receiving information from the Variations Engine, the Targeting Engine examines the Targeting filters set for each content item in the content set to determine the content to send back to the mobile device which made the request to the access point. If multiple contents match, then the Targeting Engine can determine which specific content to show using any number of selection algorithms, including random, round robin, etc.

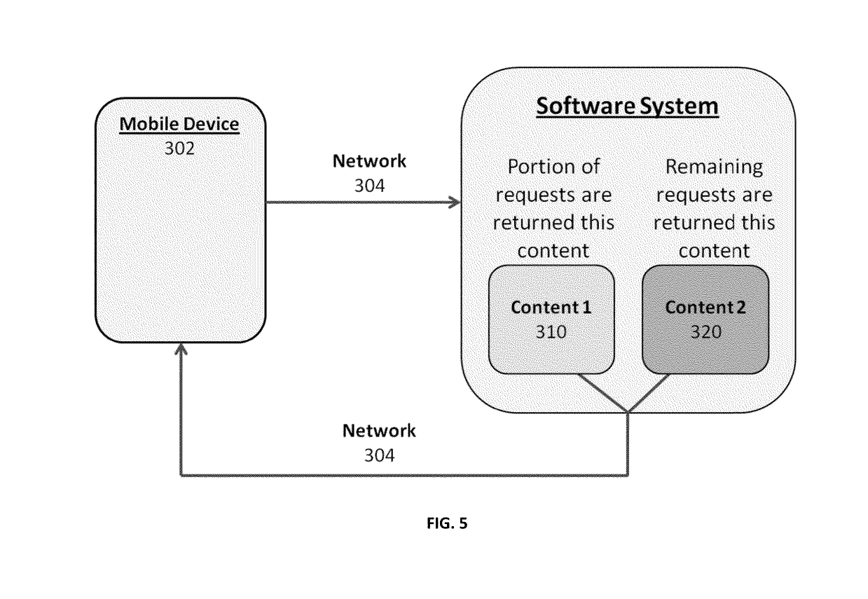

FIG. 5 shows an exemplary A/B split testing process. In this example, mobile devices 302 request content from an access point by communicating over a network 304. The software system responds to the access point request by randomly assigning a predetermined number of incoming requests to content 310 and the rest to content 320. In this example, the contents differ only in color and allow a marketer to test which version results in higher conversions (based on user response to the content).

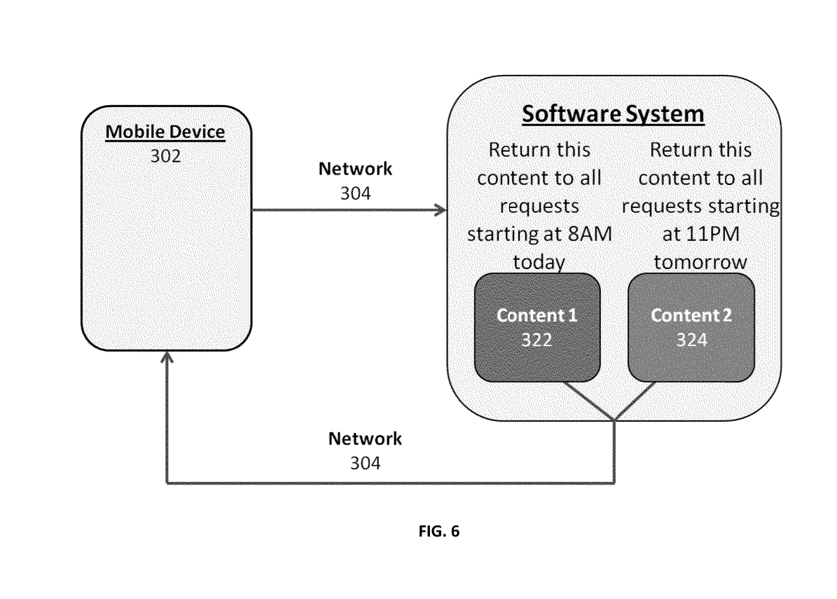

FIG. 6 shows an exemplary process for time-based delivery of content. In this example, mobile devices 302 request content from an access point by communicating over a network 304. Based on time, for example at 8 AM in Pacific Time Zone USA, the software system would show content 324. If the time is 11 PM Pacific Time Zone USA of the following day, the system would show content 322 instead of content 324. Thus, content delivery can be based on time.

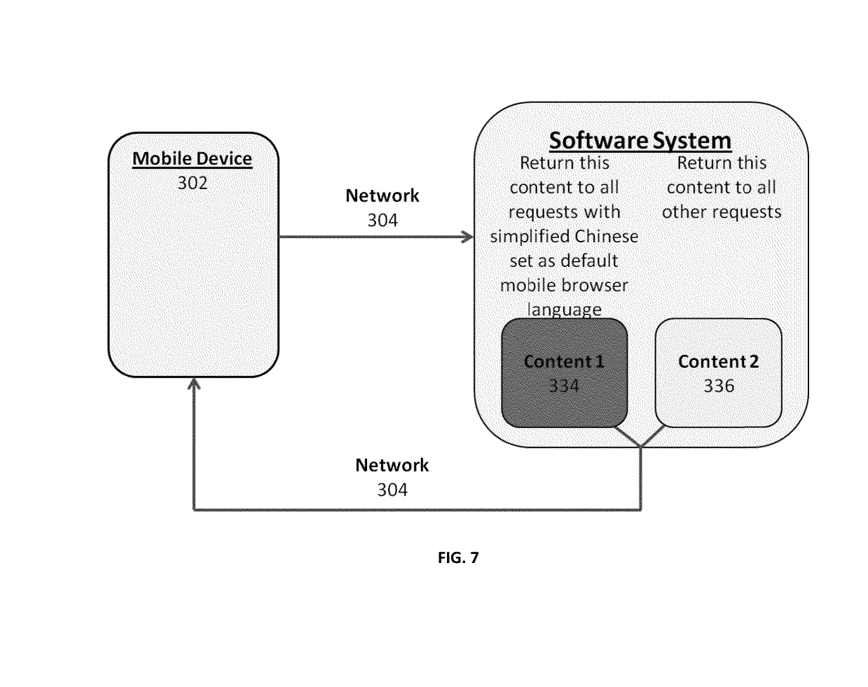

FIG. 7 shows an exemplary language based delivery of content. In this example, mobile devices 302 request content from an access point by communicating over a network 304. Requests from mobile browsers with simplified Chinese set as the default browser language are returned content 334. All other requests are returned content 336.

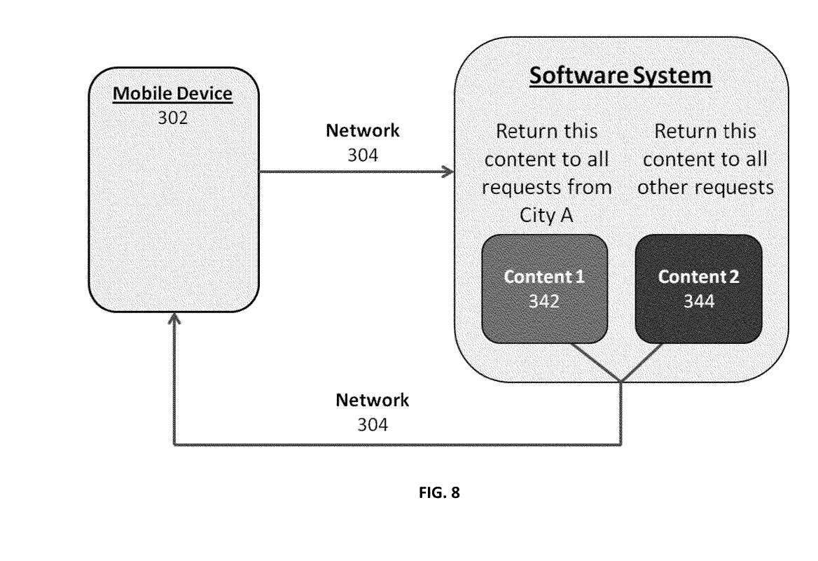

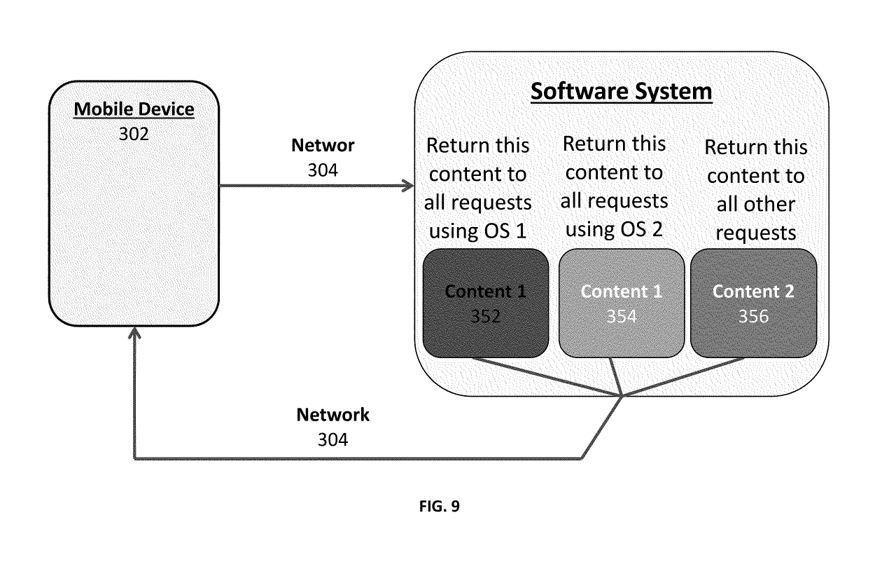

FIG. 8 shows an exemplary location based delivery of content. In this example, mobile devices 302 request content from an access point by communicating over a network 304. Requests from mobile devices in City A are returned content 342, while all other requests are returned content 344. FIG. 9 shows an exemplary delivery of content based on the operating system of the mobile device. In this example, mobile devices 302 request content from an access point by communicating over a network 304. Requests from mobile devices with operating system 1 are returned content 352, requests from mobile devices with operating system 2 are returned content 354, while all other requests are returned content 356. Similarly, content delivery could be made on the basis of mobile device type, mobile phones being returned different contents than for tablets.

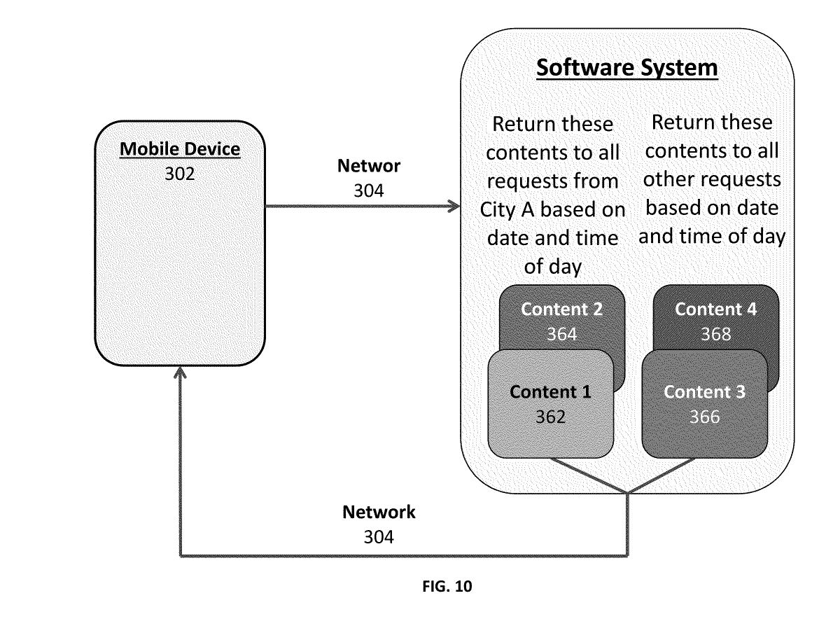

FIG. 10 shows an exemplary delivery of content by combining location and time. In this example, mobile devices 302 request content from an access point by communicating over a network 304. Requests from mobile devices in City A starting at Noon in Eastern Time Zone USA today are returned content 362, while all other requests starting at Noon in Eastern Time Zone USA are returned content 364. If the time is 5 PM Eastern Time Zone USA of the following day, the system would show requests from mobile devices in City A content 366 instead of 362. All other requests starting at 5 PM Eastern Time Zone USA are returned content 368. Thus, content delivery can be based on location and time.

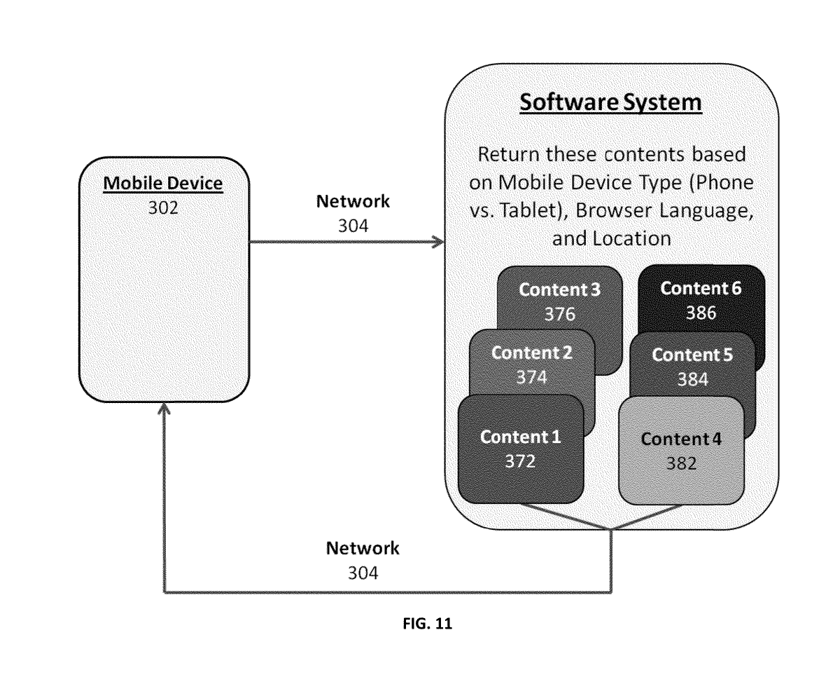

FIG. 11 shows an exemplary delivery of content by combining mobile device type (phone vs. tablet), browser language, and location. In this example, mobile devices 302 request content from an access point by communicating over a network 304. Requests from Tablets in City A with English as the browser language are returned content 372. Requests from phones in City A with English as the browser language are returned content 374. Requests from Tablets in City A with Spanish are returned content 376, while requests from phones in City A with Spanish as the browser language are returned content 382. Requests from Tablets in all other locations with all browser languages are shown content 384. Requests from phones in all other locations with all browser languages are shown content 386.

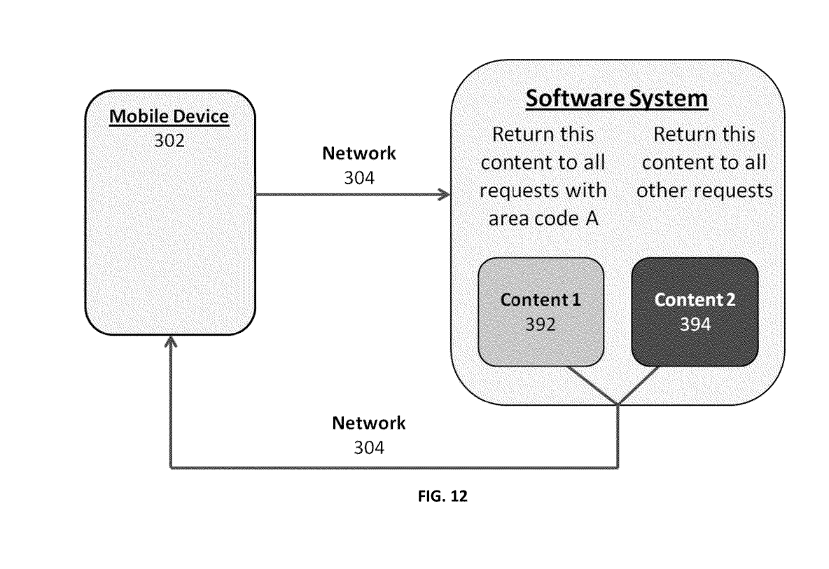

FIG. 12 shows an exemplary delivery of content by using area code. In this example, mobile devices 302 request content from an access point by communicating over a network 304. Requests from mobile devices with A area code are returned content 392. All requests from all other area codes are returned content 394.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments. Thus, the present invention is not intended to be limited to the embodiments shown herein but is to be accorded the widest scope consistent with the principles and novel features disclosed herein.

What is claimed is:

1. A method for delivering content to a mobile device, comprising:
receiving a content set consisting of a campaign, a variation selection, and one or more targeting filters;
enabling campaign access to content via a single access point and selecting content to be included in the content set based on the variation selection, and one or more predetermined times to deliver a particular content set; and
targeting filters to select content from the content set to send to the mobile device.

2. The method of claim 1, wherein the campaigns allow customers to access the content set through a single access point.

3. The method of claim 2, wherein the single access point includes a URL, a SMS keyword, short code combination, a long code combination, or a QR Code.

4. The method of claim 1, comprising receiving access request sent on a transport protocol and transport medium, providing data to a Campaigns Engine, and matching each access request by the Campaigns Engine to an individual campaign.

5. The method of claim 4, comprising sending information from the Campaigns Engine to a Variations Engine to calculate current date and time in the time zone(s) for a Campaign and comparing the current date and time against time zone attributes to select a matching Variation specified by for that Campaign.

6. The method of claim 1, comprising examining the targeting filters for each content item in the content set to select content to send to the mobile device which made the request to the access point.

7. The method of claim 6, wherein if multiple contents match, comprising determining by the Targeting Engine which specific content to show.

8. The method of claim 1, comprising specifying a time-based delivery of content.

9. The method of claim 1, comprising specifying a language-based delivery of content.

10. The method of claim 1, comprising specifying a location-based delivery of content.

11. The method of claim 1, comprising specifying an area-code-based delivery of content.

12. The method of claim 1, comprising delivering content by combining mobile device type (phone or tablet), browser language, and location.

13. The method of claim 1, comprising

14. The method of claim 1, comprising

15. A system for delivering content to a mobile device, comprising:
code for receiving a content set consisting of a campaign, a variation selection, and one or more targeting filters;
code for enabling campaign access to content via a single access point and selecting content to be included in the content set based on the variation selection, and one or more predetermined times to deliver a particular content set; and
code for targeting filters to select content from the content set to send to the mobile device.

16. The system of claim 15, wherein the campaigns allow customers to access the content set with a single access point.

17. The system of claim 16, wherein the single access point includes a URL, a SMS keyword, short code combination, a long code combination, or a QR Code.

18. The system of claim 15, comprising code for receiving access request sent on a transport protocol and transport medium providing data to a Campaigns Engine and matching each access request by the Campaigns Engine to an individual campaign.

19. The system of claim 18, comprising a code for ending information from the Campaigns Engine to a Variations Engine to calculate current date and time in the time zone(s) for a Campaign and comparing the current date and time against time zone attributes to select a matching Variation specified by for that Campaign.

20. The system of claim 15, comprising code for examining the targeting filters for each content item in the content set to select content to send to the mobile device which made the request to the access point.
